(19) United States
(12) Patent Application Publication
(10) Pub. No.: US 2025/0173762 A1
(43) Pub. Date: May 29, 2025

(54) CONTENT DELIVERY RESPONSIVE TO ELECTRIC VEHICLE CHARGING SESSION

(71) Applicant: Coulomb Technologies dba AlphaGrid, Palo Alto, CA (US)

(72) Inventors: Phillip Ellsworth STAHLFELD, Mountain View, CA (US); Lucas Michael ACKERKNECHT, San Francisco, CA (US)

(21) Appl. No.: 18/608,553

(22) Filed: Mar. 18, 2024

Related U.S. Application Data
(60) Provisional application No. 63/603,067, filed on Nov. 27, 2023.

(51) Int. Cl. G06Q 30/0251; B60L 53/65; B60L 53/67; B60L 53/68

(52) U.S. Cl. CPC G06Q 30/0266; B60L 53/65; B60L 53/67; B60L 53/68; B60L 2250/20

(57) ABSTRACT

A system can detect that a charging session to charge a vehicle started at a charging station. In response, the system can identify a user associated with the vehicle and cause a user device of the user to present content that is targeted for the user. The targeted content is configured to promote having the user visit a nearby merchant while the vehicle is being charged at the charging station.

### CROSS-REFERENCE TO RELATED APPLICATION

This application claims benefit of U.S. Provisional Patent Application No. 63/603,067, titled “ELECTRIC VEHICLE (EV) FAST CHARGER INITIATED CONTENT SERVING,” filed on Nov. 27, 2023, which is incorporated herein by this reference in its entirety.

### BACKGROUND

A charging station, also known as a charge point or electric vehicle (EV) supply equipment (EVSE), is a power supply device that supplies electric power for recharging plug-in EVs and plug-in hybrid vehicles. Public charging stations are typically found street-side or at retail shopping centers, government facilities, and other parking areas. Private charging stations are typically found at residences, workplaces, and hotels. Charging stations provide connectors that conform to a variety of international standards. For example, direct current (DC) charging stations are commonly equipped with multiple connectors to be able to charge a wide variety of vehicles that utilize different standards.

There are generally two types of EV charging stations: alternating current (AC) and DC charging stations. EV batteries can only be charged by DC electricity, while most electricity is delivered from the power grid as AC. As such, most EVs have a built-in AC-to-DC converter commonly known as an “onboard charger.” At an AC charging station, AC power from the grid is supplied to this onboard charger, which converts it into DC power to then recharge the battery. DC charging stations facilitate higher-power charging by building the converter into the charging station instead of the vehicle to avoid size and weight restrictions. The station then supplies DC power to the vehicle directly, bypassing the onboard converter. Most modern EVs accept both AC and DC power.

### BRIEF DESCRIPTION OF THE DRAWINGS

Detailed descriptions of implementations of the present invention will be described and explained through the use of the accompanying drawings.

FIG. 1 is a block diagram that illustrates an electric vehicle (EV) charging station system configured for content delivery.

FIG. 2 is a block diagram that illustrates delivery of targeted content to a user device in response to a charging session being initiated at a charging station.

FIG. 3 is a flow diagram that illustrates a process for content delivery that is responsive to a charging session at a charging station.

FIG. 4 is a block diagram of a transformer neural network, which may be used in examples of the present disclosure.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to using electric vehicle (EV) charging sessions to trigger sending content (e.g., advertisements) to user devices (e.g., smartphones) operated by drivers who are using EV charging stations to charge their EVs. A process for performing localized content delivery is hyper-targeted to EV drivers who initiate a charging session at a particular location. For example, a user can register with a charge point operator for a subscription service to access a network of charging stations. The service provider of the subscription collects and stores information about the user (e.g., payment information) to register. The user can use a mobile app on their smartphone to access a particular charging station and initiate a charging session. A user, however, does not necessarily need to register for a subscription service to access a charging station that belongs to the network.

In one example, a localized content delivery process is triggered for a charging session that satisfies criteria. A “charging session,” as used herein, can refer to a time period during which a charging station is used to charge an EV. The criteria can include registration to a subscription service to access a network of charging stations including a charging station being used during a charging session. Additional criteria can include a minimum threshold period for the charging session. For example, the minimum threshold period can correspond to two minutes commencing when a user has accessed the charging station (e.g., starts a charging session) and ending when the user has terminated access (e.g., ends the charging session).

In one example, “Plug and Charge” technology is used to identify an account of a user who initiated a charging session at a charging station. The disclosed technology can respond to initiating the charging session by sending a targeted advertisement to an electronic device (e.g., smartphone) used to initiate the charging session. A targeted advertisement is selected and communicated to the electronic device to present content for a merchant near the charging station. The Plug and Charge feature used by some charging station networks complies with ISO 15118 (Road vehicles-Vehicle to grid communication interface), which is a proposed international standard defining a vehicle to grid (V2G) communication interface for bidirectional discharging and charging EVs. ISO 15118 enables an EV to automatically identify and authorize itself to a compatible charging station on behalf of the driver to receive energy for recharging the EV's battery. The only action required by the driver is to plug the charging cable into the EV and/or charging station. The EV and the charging station identify themselves to each other by exchanging certificates that were provided beforehand via a certificate pool to facilitate payment.

Plug and Charge technology thus streamlines the EV charging experience. Instead of having to use a credit card, use an RFID tag, or use a mobile app to pay for a charging session, all that a driver needs to do is connect their EV to a charging station via a cable for AC/DC charging or Wi-Fi for wireless charging. The transaction, information about the EV and subscriber, billing details, and the charging network are protected from third-party manipulation with charging sessions that are secured with encryption, decryption, and two-way authentication.

The connection can rely on digital signatures and public key infrastructures. An example includes the vehicle to grid-public key infrastructure (V2G-PKI). Charge station operators and automakers can also handle the certificates if they are based on the ISO 15118 standard. The authentication standards allow the EV to automatically identify itself to the charging network and have the backend system “issue” validation, and then begin the charge. Each vehicle is linked to an individual billing account, whether personal, family, corporate, or other EV owner, and the transaction will be accurately documented to reflect the energy that was supplied to the EV.

Once the vehicle-charge point connection is established, identification and authorization occur across a highly secure communications link to ensure that data is exchanged in a confidential and authenticated way. Cryptographic tools are used to protect from malicious third-party actors and secure communications between the EV and the charging infrastructure, protecting the driver's personal information, the vehicle's systems that are used during the process, and the charging infrastructure.

A charging operator of one or more charging stations (e.g., a network) can partner with a content provider to provide content (e.g., advertisements) to users of the network of charging stations for one or more merchants near a particular charging station that is in use. For example, a shopping area (e.g., a mall) can have merchants and charging stations in the parking lot. The charging operator of the charging stations can partner with the merchants of the mall to present incentives that promote shopping at the merchants. The content is administered by a content provider that links the charge point operator and the merchants. As such, if the user has authorized receiving content beforehand, the service provider can provide content upon initiating a charging session.

There are several advantages of delivering location-based advertisements when a charging session has commenced. First, charging sessions typically last for a sufficient duration (˜15-60 minutes) during which a user of the charging station could visit at least one nearby merchant and potentially make a purchase. Second, charging stations are typically located near merchants such that advertising for a particular merchant in proximity to the user can influence the decision of the user to visit that particular merchant over the others in the region. Third, EV drivers tend to have more disposable income and, as such, are more likely to make a purchase at a merchant.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Targeted Content Delivery System

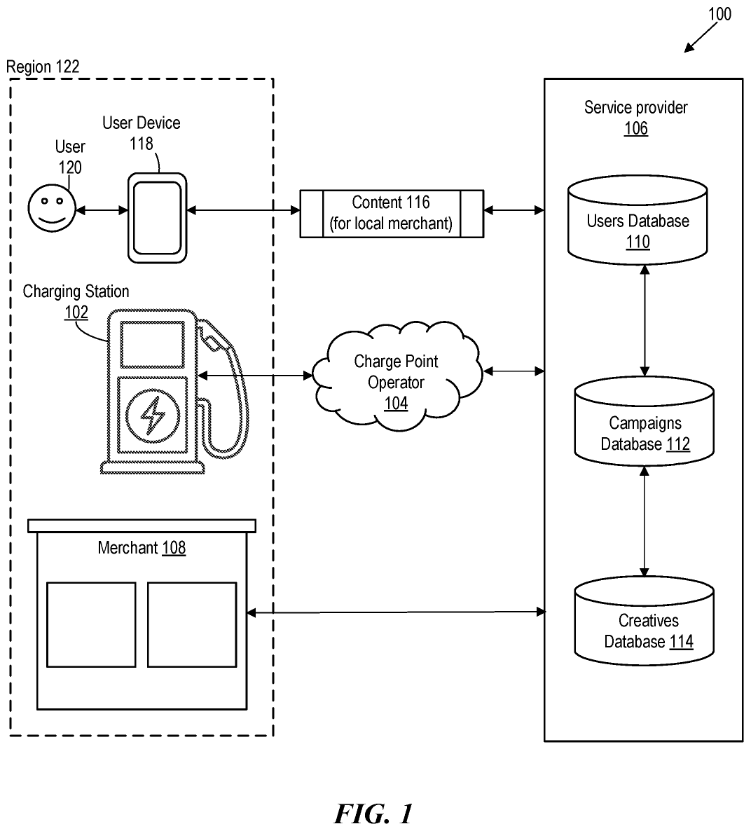

FIG. 1 is a block diagram that illustrates an EV charging station system 100 that is configured for location-based content delivery. As shown, the system 100 includes a charging station 102 supported by a charge point operator 104, which is coupled to a service provider 106 (also referred to herein as a “content provider”) that provides location-based content (e.g., advertising backend). A merchant 108 can supply content to the service provider 106. The service provider 106 includes a users database 110, a campaigns database 112, and a creatives database 114. The service provider 106 provides content 116 (e.g., advertisements) to a user device 118, which can present targeted content to a user 120 via an app on the user device 118. The charging station 102, merchant 108, user device 118, and user 120 are co-located at a region 122. That is, the charging station 102, merchant 108, user device 118, and user 120 are proximate to each other such that the user 120 can walk over to the merchant 108 as a consumer of its goods or services within a period required to complete the charging session.

The service provider 106 can serve targeted content 116 to the user 120 in response to a notification of a charging session. In particular, the process for serving targeted content 116 is initiated by a charging station 102. The users (e.g., subscribers) of the service provider can use a mobile app to associate their vehicles with accounts (e.g., using email addresses). Merchants and other establishments also create accounts with the service provider. The merchants provide campaigns with associated creatives.

When the user 120 plugs a vehicle into the charging station 102, the charging station 102 notifies the charge point operator 104 of the initiation of the charging session, and the charge point operator 104 notifies the service provider 106 of the session initiation. The service provider 106 can include or correspond to an advertising backend that uses the users database 110 to identify the user whose vehicle is associated with the charging session and then uses the campaigns database 112 to determine a suitable campaign for the charging session. If a campaign is selected, the advertising backend retrieves a creative associated with the campaign from the creatives database 114 and sends it to an app on the user device 118 via, for example, an email address that was identified for the user 120 by the service provider 106.

### API for Charge Point Operators

The service provider 106 can expose an application programming interface (API) to charge point operators. The charge point operators can use the API to notify the service provider 106 when vehicles of users are plugged into particular charging stations of networks operated by the charge point operators. For example, the charge point operator 104 can use an API to notify the service provider 106 that the user 120's EV is plugged into that charging station 102. In response, the service provider 106 can select content that is targeted to the user device 118 of the user 120 while the user 120's EV is being charged. The selected content is customized for the user 120 to promote having the user 120 visit the merchant 108.

There are several different ways that users can initiate charging sessions, which trigger charge point operators to notify the service provider 106 via the API. Examples include using Plug and Charge technology to connect the charging station to the vehicle, which automatically establishes the charging session without user intervention on a separate user device. The charging station 102 and charge point operator 104 can identify the user and/or vehicle, process payment, and then begin charging a battery of the vehicle.

In another example, a user and/or vehicle is identified to the charging station via a keyless device (e.g., a fob) or near-field communication (NFC) of a user device operated by the user. The charging station 102 then processes payment information and begins the charging process. In another example, the user 120 unlocks a connector of the charging station via a mobile app on the user device 118. The charge point operator 104 receives the user's request to unlock the connector, processes payment, and unlocks the connector, the user connects the connector to the vehicle, and the charging process begins. In yet another example, the user provides a payment instrument (e.g., credit card) directly to the charging station 102.

Regardless of which method is used to initiate a charging session, the charge point operator 104 can have, on a per-charging-session basis, an identifier representing the user and/or vehicle and an identifier representing the charging station being used. Upon initiation of each charging session, the charge point operator 104 will forward this information to the service provider 106.

### Advertising Backend

The service provider 106 manages information about the users, merchants, charging networks, and/or content items stored in one or more databases. For example, information about users is stored in the users database 110, information about arrangements of content items (e.g., campaigns) is stored in the campaigns database 112, and the content items (e.g., creatives) are stored in the creatives database 114. The service provider 106 uses information associated with the charging session to identify the user 120 in the users database 110, search eligible campaigns from the campaigns database 112, retrieve one or more creatives of a selected campaign from the creatives database 114, and communicate the retrieved creatives to present at the user device 118.

In one example, a campaign is selected to maximize potential revenue. Selection involves finding a group of campaigns that is applicable to specific charging station or a particular charging session and then selecting a particular campaign that maximizes long-term revenue. For example, consider the case where there are two eligible campaigns: campaign A and campaign B. Campaign A has a bid of $0.25 per impression (e.g., presenting to a user) and $1.00 for conversion, while campaign B has a bid of $0.15 per impression and $0.50 for conversion. Further, assume the conversion rate for campaign A is 10% and for campaign B is 90%. The long-term revenue for campaign A is $0.33 (0.25+0.10*1.00) whereas the long-term revenue for campaign B is $0.60 (0.15+0.90*0.50). Hence, campaign B should be selected.

In one example, the users database 110 stores a list of vehicle identifiers per user so that if a charging session notification only includes a vehicle identifier, the service provider 106 can still look up the user associated with that vehicle. Doing so decreases the reliance on charge point operators having to maintain registries of user and vehicle pairs, which is common for some charge point operators that only accept payment methods directly at the charging stations.

### Establishment Frontend

A frontend component (e.g., web application, mobile application) of the service provider 106 is used by merchants to administer content. In one example, content includes creatives of ad campaigns where each campaign defines creatives that will be presented to the user. An ad creative typically includes interactive elements to convey a message and promote a product or service. Examples of creative elements include a combination of text, images, videos, links, and/or quick-response (QR) codes. A good ad creative helps to catch the attention of readers and educates the readers about what is being offered and about the merchant offering the goods or services.

A campaign can define or include a bid that represents an amount that a merchant will pay for having their creative shown to a user and/or an amount that represents what a merchant is willing to pay for “conversion” from the creative. The campaign can also include criteria including a set of constraints for where and/or when to run the campaign. Examples of constraints include only running the campaign at particular charging stations, only running the campaign between certain hours (e.g., 4:00 p.m.-6:00 p.m.), limiting a campaign to a number of users or per user (e.g., one per user), or limiting a campaign to a particular duration or number or time period (e.g., 10 per day).

Merchants can design campaigns and creatives to incentivize users of charging stations to visit their establishments and make purchases. For example, the creatives can contain links/codes representing discounts, rebates, and special offers. In one example, a Mexican food restaurant that is launching a breakfast taco for the first time could create a creative offering a “buy one, get one free” breakfast taco associated with a campaign that runs when drivers plug their EVs into nearby charging stations between 6:00 a.m. and 9:00 a.m.

### Mobile App

A user device can run a mobile app that serves several purposes. For example, the mobile app can associate users with vehicles, present targeted content (e.g., ads) to the user, and/or allow users to find participating charging stations. In one example, when the user opens the app on a user device for the first time, the user is instructed to create an account and register for a location-based service. The account information is stored in a users database. Once the user has created an account, the user can be given the option to register one or more vehicles with their account.

There are several different ways that the user can register a vehicle with the user's account. For example, the user can manually enter an identifier of a vehicle into the mobile app. The identifier of the vehicle can be provided by an owner of the vehicle or from another app (e.g., from an OEM's app). In another example, the vehicle is registered with a user's account through an agent such as a charge point operator. In this situation, the end user could grant permission for a charge point operator to contact the service provider on the user's behalf to provide the vehicle identifier. In yet another example, the vehicle can be registered with the user's account through an onboarding process.

The mobile app could instruct the user to go to a charging station that is associated with a charge point operator. While at the charging station, the user can open the mobile app and select the charging station that the user is planning to use to charge a vehicle. The user can then plug into that charging station. This allows the charge point operator to associate an incoming charging session initialization notification with the user who selected that charging station. Once the user has been onboarded, the user can specify their preferences for types of content (e.g., advertisements) to receive and when/where the user would like to receive the content. Subsequently, upon plugging the user's vehicle into a charging station, the user will receive content from local establishments.

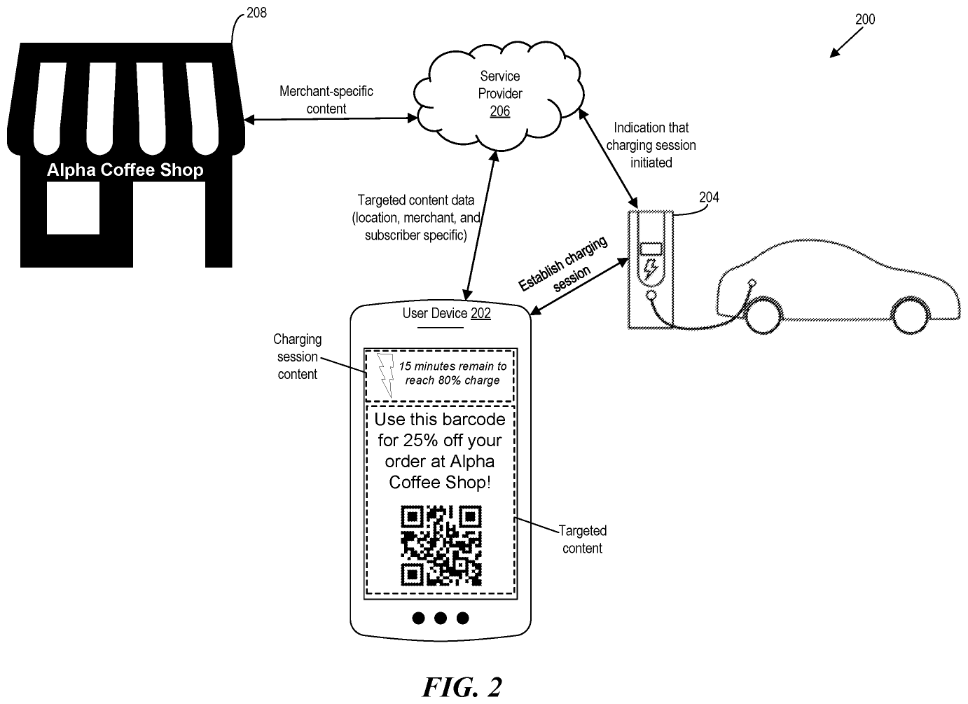

FIG. 2 is a block diagram 200 that illustrates delivery of targeted content to a user device 202 in response to a charging session initiated at a charging station 204. As shown, the user device 202 is a smartphone that includes a display for presenting content to a user. The user device 202 can host a mobile app that is supported by a charge point operator (not shown) that operates the charging station 204.

In one example, the user has a subscription that enables rapid access to the charging station 204 without needing to, for example, input personal information (e.g., payment information) to establish a charging session. That is, the user inputs personal information required to use the charging network beforehand when registering for the subscription. In addition to payment information, the personal information can include personal preferences submitted by the subscriber. Examples include preferences for food, shopping, and/or social activities. In addition to personal preferences, personal information can also include household income, household structure, and residence information. Further, personal information about the subscriber can be inferred from the type of EV being charged. For example, a subscriber that owns a luxury-brand EV probably has more disposable income compared to a subscriber who owns an economy-brand EV.

The mobile app on the user device 202 can be used to establish a charging session with the charging station 204. For example, a user of the user device 202 can open the mobile app and select the charging station 204 to initiate the charging session when the user plugs the cable of the charging station 204 into the EV's port. In another example, the charging station 204 implements Plug and Charge technology such that the user is recognized in response to the charging cable being plugged into the EV port without needing to operate the user device 202. The service provider 206 is notified that a charging session was initiated at the charging station 204 by the user.

The service provider 206 can store information regarding the locations of charging stations in its network, information about subscribers to its services, and merchant content provided by merchants (e.g., merchant 208). The information about the subscribers can include personal information. The locations of the merchants stored in a database of the service provider 206 can be mapped to locations of charging stations and ranked based on the relative distance between charging stations and respective merchants. For example, the database can sort a list of merchants based on their physical closeness to a particular charging station. The service provider 206 can also store in its database information about the types of charging stations in its network.

A charging station (e.g., charging station 204) can be classified into one of multiple types such as Level 1 (Slow Charging), Level 2 (Fast Charging), or Level 3 (Rapid Charging). Level 1 and Level 2 are both AC-type charging stations, whereas Level 3 is a DC-type charging station. As the level of charging raises, the charging speed reduces. The higher the power of EV charging, the less time it takes to get charged. The following table shows the EV charging speed for Level 1, Level 2, and Level 3 charging stations. The time to charge the EV with a 60-kWh battery is the time to raise the battery's charge from 10% to 80%.

| Charging | Power | | Range Added | | Time to Charge | |
|---|---|---|---|---|---|---|
| Level | Delivery | | per Hour | | 60 kWh EV | |
| Level 1 | 1-1.4 | kW | 3-5 | miles | 30-40 | hours |
| Level 2 | 3.9-19.2 | kW | 12-80 | miles | 2.5-4.5 | hours |
| Level 3 | 24-300 | kW | 75-1,200 | miles | 30-40 | minutes |

The Level 1 charging stations are mostly found in households where an EV owner can recharge their vehicle in the comfort and convenience of their home and routine. The Level 2 charging stations are mostly found in public places such as supermarkets, public parks, retail shops, leisure centers, and else. The Level 3 charging stations are DC charging stations that convert the AC incoming into DC at the charging station.

The service provider 206 can target content for a subscriber based on the information stored in its database to increase the conversion rate of the subscribers at the merchant 208 while the subscriber is charging an EV at the charging station 204. Hence, the selected target content can depend not only on preferences and demographic information about the subscriber but also on the particular charging session data (e.g., type of charging station). For example, the amount of time required to charge an EV at a particular charging station, given the type of charging station (e.g., slow, fast, rapid) and the charge of the EV's battery, the service provider 206 can select content that prompts the subscriber to visit a merchant for a particular activity that can be completed within the time allowed for charging the vehicle. For example, the service provider 206 can offer the subscriber a discount for coffee at the merchant 208 if charging the EV to a desired level only requires 10 minutes, whereas the service provider can offer the subscriber a discount for a local restaurant (not shown) if charging the EV to the desired level will require at least one hour. In the illustrated example, the user device 202 displays an offer to the subscriber for discounted coffee at the nearby merchant while the EV reaches a desired charge of 80% in 15 minutes.

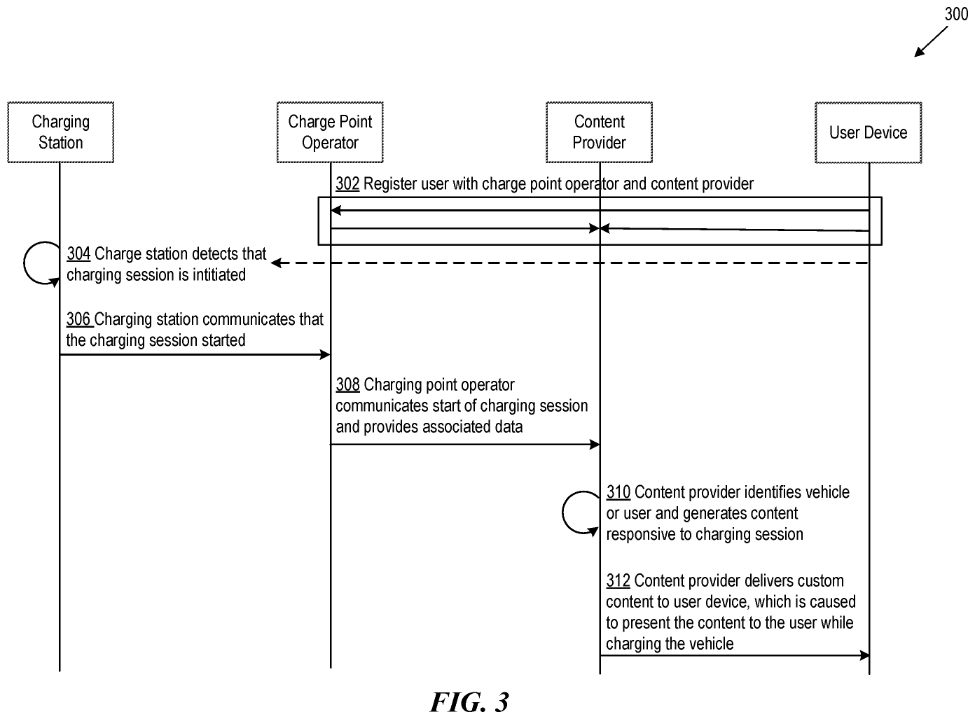

FIG. 3 is a flow diagram that illustrates processes 300 performed by a system configured to deliver content in response to initiating a charging session at a charging station. The system is configured to reduce greenhouse gas emissions by promoting utilization of electric or hybrid vehicles instead of fossil fuel-powered vehicles, with content from content providers that offer incentives to utilize a network of charging stations. The system can include a charging station, a charge point operator, a content provider, and a user device (e.g., wireless device). The system includes at least one hardware processor and at least one non-transitory memory storing instructions, which, when executed by the at least one hardware processor, cause the system to perform the processes 300.

In some implementations, the system can be configured to provide location-based advertisement services. For example, the charging station can be located in a region that includes one or more merchants. The region can be any public space with a parking area. Examples include a retail shopping center, a government facility, an office building, a hotel or motel, a recreational area, an airport, or a sports or concert venue. The content provider can include an advertisement backend that is configured to maintain a users database, a campaign database, and a content database. The users database is configured to store information identifying vehicles associated with users of the network of charging stations. The campaign database is configured to store content campaigns for merchants, and the content database is configured to store content items for the content campaigns. As such, the content provider can identify multiple content campaigns for the one or more merchants located in the region that includes the charging station.

At 302, a user is registered with the charge point operator and with a content provider. First, the user is registered with a service administered by the charge point operator that operates a network of charging stations. The charge point operator establishes and stores an account that links a vehicle to the user. Second, the user is registered with a content provider configured to deliver content items to a user device. The content provider can establish and store an account for the user that likewise links the vehicle to the user and can additionally store user preferences for content. The user or an agent on behalf of the user can authorize delivery of content to a user device from a content provider. Thus, the user can use the user device to directly register with the content provider or the user can opt in with the charge point operator to register with the content provider on the user's behalf. The charge point operator then establishes an association between the user and the content provider.

At 304, the charging station detects that a charging session has been initiated to charge a battery of a vehicle linked to the user. For example, the charging station can detect that a connector of the charging station was plugged into the vehicle, detect a short-range wireless signal emitted by a device (e.g., fob) operated by the user at the charging station, or detect an input at the user device that requests to unlock the connector of the charging station.

At 306, the charge point operator determines that the charging session started at the charging station. For example, data indicative of the charging session is generated at the charging station and communicated to the charge point operator. The data communicated to the charge point operator can identify the vehicle, the user, a capacity of a battery of the vehicle, a current charge level of the battery of the vehicle, a desired charge level of the battery of the vehicle, a type of charging station, and/or a rate of charge of the charging station.

At 308, the charge point operator notifies the content provider that the charging session started at the charging station. The notification forwards or includes information about the charging session, including information that identifies the vehicle or user. In one example, the content provider exposes an API to the charge point operator and receives, via the API, an indication that the charging session has been initiated at the charging station and associated data about the charging session.

At 310, in response to the indication that the charging session started, the content provider can identify the user associated with the vehicle based on the identifying information forwarded from the charge point operator. The content provider can identify the user from among multiple users registered with the charge point operator. In one example, the content provider retrieves an identity of the user from the subscribers database, selects, based on the identity of the subscriber, a content campaign stored in the campaign database, and retrieves, from the content database, a particular content item for the particular content campaign. As such, content items can correspond to one or more creatives of a campaign for a local merchant and the campaign is configured based in part on the identifying information of the user. The content provider can, for example, select content campaigns based on a user's personal preferences and sort the content campaigns based on an estimated time period to redeem respective offers while a vehicle is being charged.

Specifically, the content provider can create or retrieve one or more content items having one or more interactive elements configured to convey a message to cause the user to visit the one or more merchants while the battery of the vehicle is being charged by the charging station. The one or more content items satisfy a criterion associated with the user. Examples of the criterion include a personal preference of the user, a preference of a particular merchant of the one or more merchants, a time constraint for performing an action prior to termination of the charging session, or a distance between the charging station and each of the one or more merchants co-located with the charging station in the region.

At 312, the content provider delivers the one or more content items to the user device. Specifically, the content provider activates or communicates the one or more content items to the user device over a telecommunications network, computer network, or other communications network. As such, the user device is caused to present the one or more content items prior to termination of the charging session due to the battery of the vehicle being charged to a preset value. Accordingly, a criterion for content items can correspond to a time period that is estimated to redeem or accept an offer included in the one or more content items being equal to or less than the time remaining to charge the battery. In one example, the content provider generates a QR code to receive a discount at the one or more merchants. The content item presented at the user device includes the QR code, which expires at or before a point in time when the EV is expected to be charged to the preset value (e.g., 80% charge).

In an example implementing a generative artificial intelligence system, the system can retrieve data of the user including a personal preference and demographic information, retrieve data about the one or more merchants including location-based or time-constrained advertisement campaigns, and generate the one or more content items as an output of a large language model (LLM) based on inputs including, among other things, the personal preference, the demographic information, and the location-based or time-constrained advertisement campaigns.

### Transformer for Neural Network

The disclosed service provider can include or be associated with a generative artificial intelligence system configured to generate the targeted content. To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

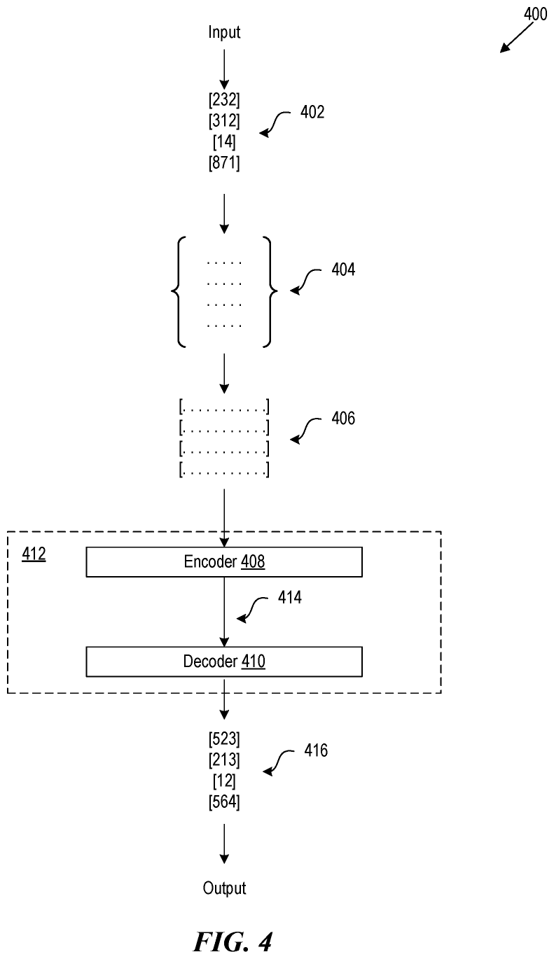

FIG. 4 is a block diagram 400 of an example transformer 412, which is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 412 includes an encoder 408 (which can include one or more encoder layers/blocks connected in series) and a decoder 410 (which can include one or more decoder layers/blocks connected in series). Generally, the encoder 408 and the decoder 410 each include multiple neural network layers, at least one of which can be a self-attention layer. The parameters of the neural network layers can be referred to as the parameters of the language model.

The transformer 412 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 412 is trained to perform certain functions on other input formats than natural language input. For example, the input can include objects, images, audio content, or video content, or a combination thereof.

The transformer 412 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 4 illustrates an example of how the transformer 412 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 4, a short sequence of tokens 402 corresponding to the input text is illustrated as input to the transformer 412. Tokenization of the text sequence into the tokens 402 can be performed by some pre-processing tokenization module such as, for example, a byte-pair encoding tokenizer (the “pre” referring to the tokenization occurring prior to the processing of the tokenized input by the LLM), which is not shown in FIG. 4 for brevity. In general, the token sequence that is inputted to the transformer 412 can be of any length up to a maximum length defined based on the dimensions of the transformer 412. Each token 402 in the token sequence is converted into an embedding vector 406 (also referred to as “embedding 406”).

An embedding 406 is a learned numerical representation (such as, for example, a vector) of a token that captures some semantic meaning of the text segment represented by the token 402. The embedding 406 represents the text segment corresponding to the token 402 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 406 corresponding to the “write” token will be closer to another embedding corresponding to the “jot down” token in the vector space as compared to the distance between the embedding 406 corresponding to the “write” token and another embedding corresponding to the “summary” token.

The vector space can be defined by the dimensions and values of the embedding vectors. Various techniques can be used to convert a token 402 to an embedding 406. For example, another trained ML model can be used to convert the token 402 into an embedding 406. In particular, another trained ML model can be used to convert the token 402 into an embedding 406 in a way that encodes additional information into the embedding 406 (e.g., a trained ML model can encode positional information about the position of the token 402 in the text sequence into the embedding 406). In some implementations, the numerical value of the token 402 can be used to look up the corresponding embedding in an embedding matrix 404, which can be learned during training of the transformer 412.

The generated embeddings 406 are input into the encoder 408. The encoder 408 serves to encode the embeddings 406 into feature vectors 414 that represent the latent features of the embeddings 406. The encoder 408 can encode positional information (i.e., information about the sequence of the input) in the feature vectors 414. The feature vectors 414 can have very high dimensionality (e.g., on the order of thousands or tens of thousands), with each element in a feature vector 414 corresponding to a respective feature. The numerical weight of each element in a feature vector 414 represents the importance of the corresponding feature. The space of all possible feature vectors 414 that can be generated by the encoder 408 can be referred to as a latent space or feature space.

Conceptually, the decoder 410 is designed to map the features represented by the feature vectors 414 into meaningful output, which can depend on the task that was assigned to the transformer 412. For example, if the transformer 412 is used for a translation task, the decoder 410 can map the feature vectors 414 into text output in a target language different from the language of the original tokens 402. Generally, in a generative language model, the decoder 410 serves to decode the feature vectors 414 into a sequence of tokens. The decoder 410 can generate output tokens 416 one by one. Each output token 416 can be fed back as input to the decoder 410 in order to generate the next output token 416. By feeding back the generated output and applying self-attention, the decoder 410 can generate a sequence of output tokens 416 that has sequential meaning (e.g., the resulting output text sequence is understandable as a sentence and obeys grammatical rules). The decoder 410 can generate output tokens 416 until a special [EOT] token (indicating the end of the text) is generated. The resulting sequence of output tokens 416 can then be converted to a text sequence in post-processing. For example, each output token 416 can be an integer number that corresponds to a vocabulary index. By looking up the text segment using the vocabulary index, the text segment corresponding to each output token 416 can be retrieved, the text segments can be concatenated together, and the final output text sequence can be obtained.

In some implementations, the input provided to the transformer 412 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 4,048 input tokens), and is able to generate a large number of tokens as output (e.g., up to 4,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API of the service provider 106). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computer System

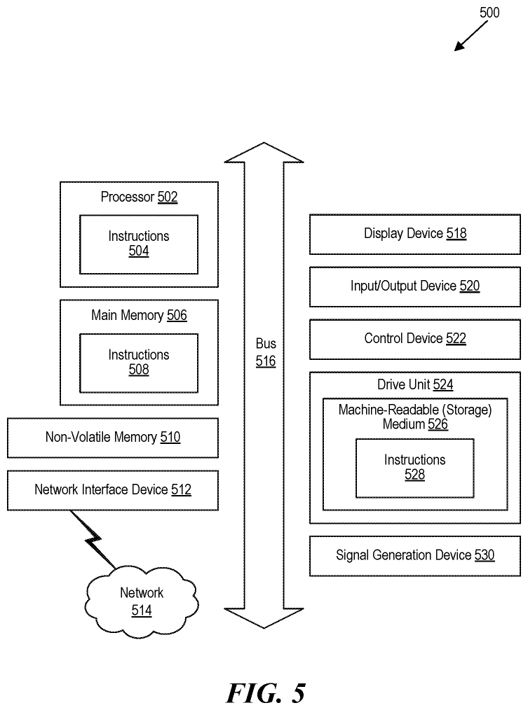

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A system comprising:
at least one hardware processor; and
at least one non-transitory memory storing instructions, which, when executed by the at least one hardware processor, cause the system to:
determine that a charging session has been initiated to charge a battery of an electric vehicle (EV) at a charging station,
wherein the charging station is located in a region that includes one or more merchants, and
wherein the charging session is associated with identifying information of the EV;
identify a user associated with the EV based on the identifying information communicated to a charge point operator of the charging station in response to the charging session being initiated,
wherein the user is identified from among multiple users registered with a charge point operator that operates a network of charging stations including the charging station;
retrieve one or more content items having one or more interactive elements configured to convey a message to cause the user to visit the one or more merchants while the battery of the EV is being charged by the charging station; and
cause a user device of the user to present the one or more content items prior to termination of the charging session due to the battery of the EV being charged to a preset value.

2. The system of claim 1, wherein the one or more content items satisfy a criterion associated with the user, and wherein the criterion includes:
a personal preference of the user,
a preference of a particular merchant of the one or more merchants,
a time constraint for accepting an offer included in the one or more content items prior to termination of the charging session, or
a distance between the charging station and each of the one or more merchants located with the charging station in the region.

3. The system of claim 1 further caused to:
retrieve data of the user including a personal preference or demographic information;
retrieve data about the one or more merchants including location-based or time-constrained advertisement campaigns; and
generate the one or more content items as an output of a large language model (LLM) based on inputs including the personal preference or the demographic information and the location-based or time-constrained advertisement campaigns.

4. The system of claim 1 further caused to:
identify a personal preference of the user, the personal preference being associated with particular goods or services of merchants,
wherein the personal preference is stored in association with the identifying information, and
wherein the one or more content items satisfy the personal preference of the user.

5. The system of claim 1 further caused to:
determine a time remaining to charge the battery to the preset value, wherein the one or more content items satisfy a criterion corresponding to an estimate for a time period to redeem an offer included in the one or more content items being less than the time remaining to charge the battery to the preset value.

6. The system of claim 1, wherein to determine that the charging session has been initiated to charge the battery of the EV at the charging station comprises causing the system to:
detect that a connector of the charging station is plugged into the EV,
detect, at the charging station, a short-range wireless signal emitted by a device operated by the user, or
detect an input at the user device that requests to unlock the connector of the charging station.

7. The system of claim 1 comprising a content provider configured to deliver the one or more content items to the user device, wherein to determine that the charging session has been initiated to charge the battery at the charging station comprises causing the system to:
receive a notification from the charge point operator that the charging session has been initiated to charge the battery of the EV at the charging station, wherein the notification identifies the EV or the user and identifies the charging station.

8. The system of claim 1 comprising a content provider configured to deliver the one or more content items to the user device, the content provider being caused to:
expose an application programming interface (API) to the charge point operator;
receive, via the API, an indication that the charging session has been initiated at the charging station; and
communicate the one or more content items to the user device over a telecommunications network or computer network.

9. The system of claim 1 comprising a content provider configured to deliver location-based advertisement content, wherein to determine that the charging session has been initiated to charge the battery of the EV at the charging station comprises causing the system to:
receive a notification from the charge point operator that the charging session has been initiated to charge the battery of the EV at the charging station, wherein the notification includes the identifying information of the EV or the user.

10. The system of claim 1, wherein the region that includes one or more merchants comprises:
a parking area in which the charging station is located, and
a retail shopping center,
a government facility,
an office building,
a hotel or motel,
a recreational area,
an airport, or
a sports or concert venue.

11. The system of claim 1 comprising a service provider that includes an advertising backend that is configured to deliver a location-based ad creative of an ad campaign to the user device, wherein the system is caused to:
search a users database, based on the identifying information, for user information about the user including a user preference,
wherein the identifying information includes information that is used to identify the EV, the user, or payment information;
select, based on the user preference, an ad campaign from a campaign database;
retrieve, based on the ad campaign, the ad creative; and
communicate, over a communications network to the user device, the ad creative.

12. The system of claim 1 further caused to, prior to determining that the charging session has been initiated:
register the user with a content provider configured to deliver the one or more content items to the user device; and
establish an account for the user that links to the EV and stores user preferences for content.

13. The system of claim 1:
wherein the one or more content items correspond to one or more creatives of a campaign for the merchant,
wherein the campaign is configured based in part on the identifying information, and
wherein the identifying information includes a type of the EV, an expected time to charge the EV, or a time remaining to charge the EV.

14. A system comprising:
at least one hardware processor; and
at least one non-transitory memory storing instructions, which, when executed by the at least one hardware processor, cause the system to:
register a subscriber to a subscription service administered by a charge point operator that operates a network of charging stations,
wherein registration links a vehicle to the subscriber;
receive an indication that the subscriber authorizes delivery of content from a content provider to a wireless device of the subscriber;
establish an association with the content provider configured to administer:
a subscribers database configured to store information identifying vehicles associated with subscribers of the content provider,
a campaign database configured to store content campaigns for merchants, and
a content database configured to store content items for the content campaigns;
receive an indication that the vehicle of the subscriber is plugged into a charging station of the network of charging stations; and
in response to the indication that the vehicle of the subscriber is plugged into the charging station, cause the content provider to:
retrieve, from the subscribers database, an identity of the subscriber;
select, based on the identity of the subscriber, a content campaign stored in the campaign database;
retrieve, from the content database, a particular content item for the particular content campaign; and
communicate the content item to the wireless device of the subscriber, wherein the content item is configured to present at the wireless device during a charging operation to charge the vehicle at the charging station.

15. The system of claim 14, wherein to select the content campaign stored at the campaign database comprises causing the content provider to:
identify multiple content campaigns for one or more merchants located in a region that includes the charging station; and
sort the multiple content campaigns based on an estimated time period to redeem respective offers of the multiple content campaigns,
wherein the selected content campaign includes an offer that is redeemable within an estimated time period that is equal to or less than a time period remaining to charge the vehicle to a preset value.

16. The system of claim 14, wherein to receive the indication that the vehicle of the subscriber is plugged into the charging station comprises causing the system to detect, at the charging station:
a connector of the charging station plugged into the vehicle,
a short-range wireless signal emitted by a device operated by the subscriber, or
an input at the wireless device that requests to unlock the connector of the charging station.

17. The system of claim 14:
wherein the content campaigns are advertising campaigns for one or more merchants located in a region that includes the charging station,
wherein the content for the content campaigns is configured based on charging information obtained when the vehicle is plugged into the charging station, and
wherein the charging information includes:
a capacity of a battery of the vehicle,
a current charge level of the battery of the vehicle,
a desired charge level of the battery of the vehicle, and
a rate of charge of the charging station.

18. The system of claim 14 further caused to:
reduce greenhouse gas emissions by promoting utilization of electric vehicles instead of fossil fuel-powered vehicles with content from the content providers that offer incentives to utilize the network of charging stations.

19. A method for reducing greenhouse gas emissions by promoting utilization of electric vehicles (EVs) instead of fossil fuel-powered vehicles, the method comprising:
detecting that a charging session has been initiated to charge a battery of an EV at a charging station,
wherein the charging station is located in a region that includes one or more merchants;
in response to the charging session being initiated, identifying a user associated with the EV based on identifying information communicated to a charge point operator of the charging station; and
causing a user device of the user to present content that is targeted for the user and presented prior to termination of the charging session due to the EV being charged to a preset value,
wherein the content includes an interactive element configured to convey a message to cause the user to visit the one or more merchants while the EV is being charged to the preset value.

20. The method of claim 19 further comprising:
generating a quick-response code to receive a discount at the one or more merchants,
wherein the content includes the quick-response code, and
wherein the quick-response code expires at or before a point in time when the EV is expected to be charged to the preset value.
